(19) United States
(12) Patent Application Publication
(10) Pub. No.: US 2020/0081935 A1
(43) Pub. Date: Mar. 12, 2020

(54) METHOD AND DEVICE FOR RECOGNIZING AN EVENT

(71) Applicant: ROBERT BOSCH GMBH, Stuttgart (DE)

(72) Inventor: Peter Bakucz, Klosterlechfeld (DE)

(21) Appl. No.: 16/469,074

(22) PCT Filed: Dec. 13, 2017
(86) PCT No.: PCT/EP2017/082663

§ 371 Date: Jun. 12, 2019

(30) Foreign Application Priority Data
Dec. 13, 2016 (DE) 102016224863.4

(51) Int. Cl. G06F 17/14

(52) U.S. Cl. CPC G06F 17/148

(57) ABSTRACT

An event recognition method, for example that is performed by a device that includes a sensor unit and a processing unit, includes detecting at least one measured value pattern; multifractally determining a Hölder exponent based on the first measured value pattern; determining a mother wavelet based on the Hölder exponent; obtaining a plurality of sensor measured values within a time period; generate transformed measured values by wavelet transformation of the detected measured values using the determined mother wavelet; identifying occurrence of the event based on a determination that at least one of the transformed measured values exceeds a limiting value; and generating a signal signaling the identification of the occurrence of the event.

### CROSS-REFERENCE TO RELATED APPLICATIONS

The present application is the national stage of International Pat. App. No. PCT/EP2017/082663 filed Dec. 13, 2017, and claims priority under 35 U.S.C. § 119 to DE 10 2016 224 863.4, filed in the Federal Republic of Germany on Dec. 13, 2016, the content of each of which are incorporated herein by reference in their entireties.

### FIELD OF THE INVENTION

The present invention relates to a method for recognizing an event. In the method, a suitable mother wavelet is determined for a measured value pattern and a wavelet transformation of the detected measured values is carried out depending on the mother wavelet in order to recognize the event. The invention additionally relates to a device including a processing unit and a sensor unit, the processing unit being configured to carry out a method according to the present invention.

### BACKGROUND

The determination of a suitable mother wavelet is disclosed, for example, in Mahmoud I. Al-kadi et al., “Compatibility of Mother Wavelet Functions with the Electroencephalographic Signal,” IEEE EMBS Conference on Biomedical Engineering and Sciences (IECBES), Langkawi (2012). The most optimal mother wavelet is determined for a specific signal in that a plurality of mother wavelets is tested.

Furthermore, it is known, for example, from Antoine Ayache et al., “On the identification of the pointwise Hölder exponent of the generalized multifractional Brownian motion,” Stochastic Processes and their Applications, pp. 119-156, Volume 111, Issue 1, can (2004) how the Hölder exponent of a signal can be multifractally determined.

### SUMMARY

The present invention relates to a method for recognizing an event. In this case, at the beginning, at least one first measured value pattern is detected and stored in a method step a. This first measured value pattern characterizes the event. Subsequently, a Hölder exponent is multifractally determined in a method step b as a function of the first measured value pattern. Thereupon, a mother wavelet is determined in a method step c as a function of the Hölder exponent. In a subsequent method step d, a plurality of measured values of the sensor unit is detected within a time period. Thereafter, in a method step e, transformed measured values are generated by a wavelet transformation of the detected measured values as a function of the determined mother wavelet. Thereupon, the transformed measured values are compared with a stored limiting value in a method step f. If at least one of the transformed measured values exceeds the stored limiting value, it is determined in a method step g that the event, which is characterized by the first measured value pattern, has occurred. Finally, a signal is generated in a method step h, which signals that the event has occurred.

It is advantageous in this case that an optimal mother wavelet is determined, depending on the detected measured value pattern, in order to recognize the event as exactly as possible. The signal-to-noise-ratio is hereby improved. In particular, non-linear measured values, which typically occur in the detection of measured values of associated events, are thereby approximated particularly well based on the determination of the mother wavelet as a function of the Hölder exponent. In addition, such a determination requires only a small number of measured values, whereby a recognition of the event can be carried out faster. Furthermore, in contrast to the Fourier transform, it is advantageous that information about local drifts, about tendencies, and also about short-term changes of the measured values is preserved in the wavelet transformation.

In an example embodiment of the method according to the present invention, it is provided that a mother wavelet is determined in method step c, in that the mother wavelet is approximated with the aid of a B-spline scaling function as a function of the Hölder exponent.

It is hereby advantageous that the mother wavelet can be optimally approximated with the aid of the B-spline scaling function. In addition, only little computational effort is necessary. Furthermore, in contrast to the Fourier transform, it is advantageous that only whole numbers and no complex numbers must be computed in the wavelet transformation.

In an example embodiment of the method according to the present invention, it is provided after method step g, that a method step i is performed, in which it is determined at which points in time within the time period the stored limiting value is exceeded by the transformed measured values, this information being integrated in method step h into the generated signal.

It is hereby advantageous that the detected event can additionally be assigned to that point in time at which it occurred. In contrast to the Fourier transform, it is hereby advantageous that both the time information and the frequency information of the detected measured values are preserved in the wavelet transformation.

The present invention additionally relates to a device for recognizing an event, including a processing unit and a sensor unit. In this case, the processing unit is configured to detect and store a first measured value pattern that characterizes the event. Furthermore, the processing unit is configured to multifractally determine a Hölder exponent as a function of the at least one measured value pattern and additionally to determine a mother wavelet as a function of the determined Hölder exponent. In addition, the processing unit is configured to detect a plurality of measured values of the sensor unit within a time period and to generate transformed measured values through a wavelet transformation of the detected measured values as a function of the determined mother wavelet. Furthermore, the processing unit is configured to compare the transformed measured values to a stored limiting value and, if at least one of the transformed measured values exceeds the stored limiting value, to determine that the event has occurred within the time period, the processing unit being configured to generate a signal which signals that the event has occurred.

It is hereby advantageous that an optimal mother wavelet is determined, depending on the detected measured value pattern, in order to recognize the event as exactly as possible. The signal-to-noise-ratio is hereby improved. In particular, non-linear measured values, which typically occur in the detection of measured values of associated events, are thereby approximated particularly well with the aid of the determination of the mother wavelet as a function of the Hölder exponent. In addition, such a determination requires only a small number of measured values, whereby a recognition of the event can be carried out faster. Furthermore, in contrast to the Fourier transform, it is advantageous that information about local drifts, about tendencies, and also about short-term changes of the measured values is preserved in the wavelet transformation.

An example embodiment of the present invention provides that the processing unit is configured to determine the mother wavelet through approximation using a B-spline scaling function as a function of the Hölder exponent.

It is hereby advantageous that the mother wavelet can be optimally approximated using the B-spline scaling function. In addition, only little computational effort is necessary. Furthermore, in contrast to the Fourier transform, it is advantageous that only whole numbers and no complex numbers must be computed in the wavelet transformation.

An example embodiment of the present invention provides that the processing unit is configured to determine at which points in time within the time period the stored limiting value is exceeded by the transformed measured values, and to integrate this information into the generated signal.

It is hereby advantageous that the detected event can additionally be assigned to that point in time at which it occurred. In contrast to the Fourier transform, it is hereby advantageous that both the time information and the frequency information of the detected measured values are preserved in the wavelet transformation.

### BRIEF DESCRIPTION OF THE DRAWINGS

FIG. 1 illustrates a device to carry out a method according to an example embodiment of the present invention.

FIG. 2 is a flowchart that illustrates a method for recognizing an event, according to an example embodiment of the present invention.

### DETAILED DESCRIPTION

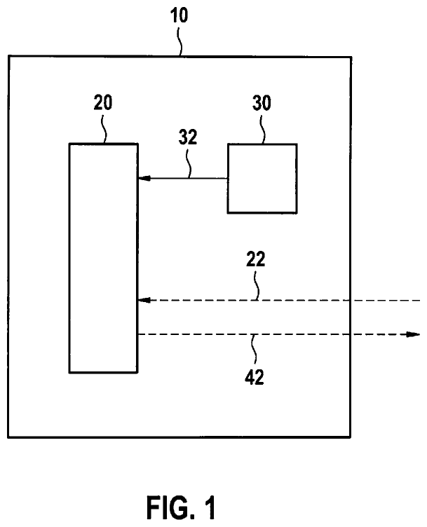

FIG. 1 shows an example embodiment of a device according to the present invention, which is configured to carry out a method according to the present invention. A device 10 is depicted. Device 10 includes a processing unit 20 and a sensor unit 30. Sensor unit 30 can, for example, be a magnetic field sensor, an acceleration sensor, a rotation rate sensor, or any arbitrary type of sensor. Processing unit 20 is, for example, a microcontroller and is connected to sensor unit 30 in such a way that a plurality of measured values 32 is detectable within a certain time period. Detection is thereby understood to mean tapping measured values 32 and at least temporarily storing these measured values 32. In particular, processing unit 20 can include an internal memory (not shown) for this purpose, or device 10 can have a memory unit (not shown) which is then bidirectionally connected to processing unit 20. Processing unit 20 is configured to detect and store at least one measured value pattern 22. This detection can be carried out, for example, directly via sensor unit 30 or also by an external communication unit of device 10 not depicted in the figures. Furthermore, processing unit 20 is configured to multifractally determine a Hölder exponent as a function of first measured value pattern 22 and additionally to determine a mother wavelet as a function of the determined Hölder exponent. Processing unit 20 is additionally configured to transform detected measured values 32 as a function of the determined mother wavelet. Transformed measured values are thus generated. Furthermore, processing unit 20 is configured to compare the transformed measured values with a stored limiting value and, upon exceeding the stored limiting value, to identify that the event, which is characterized by at least one first measured value pattern 22, has occurred within the time period, and to generate a signal 42, which signals that the event has occurred.

Optionally, processing unit 20 is additionally configured to emit generated signal 42. This can be carried out using a communication unit, in particular a wireless communication unit, not shown in the figures.

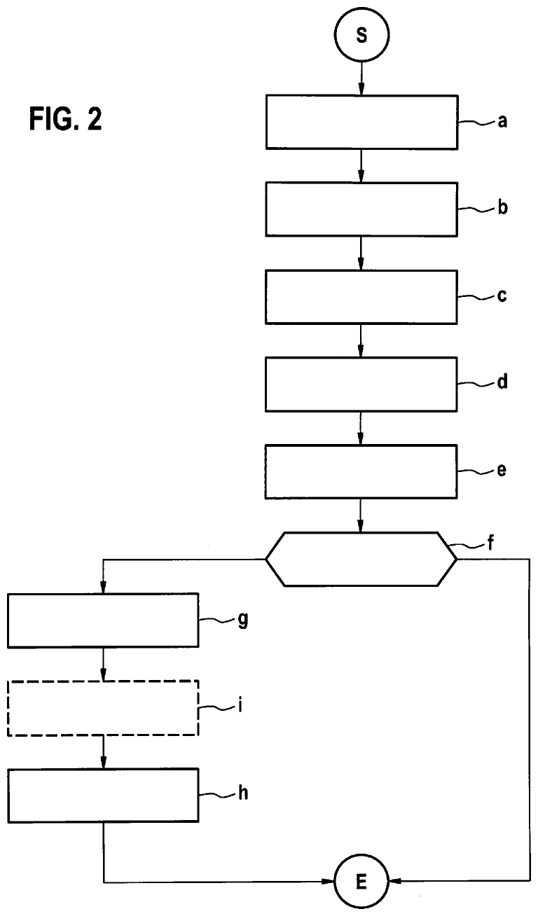

FIG. 2 illustrates a method for recognizing an event according to an example embodiment of the present invention. In this case, at the beginning, at least one first measured value pattern 22 is detected and stored in a method step a. This detection can be carried out, for example, directly via a sensor unit 30, in that the event occurs and the detected measured values are detected as measured value pattern 22. First measured value pattern 22 can, however, also be set by a user, for example, and detected in this way. This first measured value pattern 22 characterizes the event. Such an event can be, for example, a stopping of a bicycle rider at a red light, which is characterized by a typical acceleration profile of an acceleration sensor situated on the bicycle. This acceleration profile is then detected as first measured value pattern 22. Alternatively, any other event is naturally also conceivable that can be characterized by a measured value pattern and detected using a sensor. This might also be, for example, a flat point recognition of a rail vehicle, a state recognition of a parking space, or a specific profile of an EKG signal. Subsequently, in a method step b, a Hölder exponent is multifractally determined as a function of first measured value pattern 22. The Hölder exponent should thereby assume a value between 0.5 and 2 in order to facilitate a square-integrable function.

Thereupon, a mother wavelet is determined as a function of the Hölder exponent in a method step c. The determination of the mother wavelet is carried out, for example, using a B-spline scaling function that approximates the mother wavelet as a function of the determined Hölder exponent.

The B-spline scaling function is

$${β}_{+}^{a} ( x ) = \frac{{Δ}_{+}^{a + 1} {x}_{+}^{γ}}{Γ ( a + 1 )} = {\sum }_{k \geq 0} \frac{{( - 1 )}^{k} ( \begin{matrix}a + 1 \\ k\end{matrix} )}{Γ ( a + 1 )} {( x - k )}_{+}^{a} ,$$

where Γ(a+1) is defined as Γ(a+1)=∫₀^{∞}x^{a}e^{-x}dx, where x₊^{γ} is the biased energy function of

$${x}_{+}^{γ} = 〈 \begin{matrix}{x}^{a} & x \geq 0 \\ 0 & x < 0\end{matrix} ,$$

and where Δ₊^{a+1} is the fractal operator of the finite differences and a is the Hölder exponent. Thus, the B-spline scaling function determined as a function of the Hölder exponent is subsequently used as the mother wavelet.

In a subsequent method step d, a plurality of measured values 32 of sensor unit 30 is detected within a time period. For the example of the bicycle rider, an acceleration sensor with a scanning frequency of approximately 500 Hz, for example, is scanned over a specific time period. This specific time period is to be selected such that at least the event can occur within the specific time period.

Thereafter, in a method step e, transformed measured values are generated by a wavelet transformation of detected measured values 32 as a function of the determined mother wavelet.

Thereupon, the transformed measured values are compared with a stored limiting value in a method step f.

If at least one of the transformed measured values exceeds the stored limiting value, it is identified in a method step g that the event, which is characterized by measured value pattern 22, has occurred.

Finally, a signal 42 is generated in a method step h, which signals that the event has occurred.

Optionally, a method step i runs between method step g and method step h, in which it is determined at which points in time within the time period the stored limiting value is exceeded by the transformed measured values. This information is then integrated into generated signal 42 in method step h.

Furthermore, generated signal 42 can optionally be internally processed or also emitted, for example by a communication unit not depicted in the figures, in order to correspondingly respond to the recognized event. For example, if it is recognized that a bicycle rider stops at a red light, a height adjustment unit of a seat can be activated in order to shift the height of the seat into a dismount position.

1-6. (canceled)

7. A method for recognizing an event, the method comprising:
a. detecting and storing at least one measured value pattern characterizing the event;
b. multifractally determining a Hölder exponent as a function of the at least one measured value pattern;
c. determining a mother wavelet as a function of the determined Hölder exponent;
d. obtaining a plurality of measured values of a sensor within a time period;
e. generating transformed measured values through a wavelet transformation of the detected measured values using the determined mother wavelet;
f. comparing the transformed measured values with a stored threshold value;
g. identifying that the event, which is characterized by the at least one measured value pattern, has occurred within the time period responsive to a result of the comparing being that at least one of the transformed measured values exceeds the stored threshold value; and
h. generating a signal that signals that the event has occurred.

8. The method of claim 1, wherein the determination of the mother wavelet includes approximating the mother wavelet using a B-spline scaling function based on the Hölder exponent.

9. The method of claim 1, further comprising:
after method step g, determining at which points in time within the time period the stored threshold value is exceeded by the transformed measured values, wherein the generating of the signal includes integrating information of the points in time into the signal.

10. A device for recognizing an event, the device comprising:
a sensor; and
a processor, wherein the processor is configured to:
detect and store at least one first measured value pattern characterizing the event;
multifractally determine a Hölder exponent as a function of the at least one measured value pattern;
determine a mother wavelet as a function of the determined Hölder exponent;
obtain a plurality of measured values of the sensor within a time period;
generate transformed measured values through a wavelet transformation of the detected measured values using the determined mother wavelet;
compare the transformed measured values with a stored threshold value;
identify that the event, which is characterized by the at least one measured value pattern, has occurred within the time period responsive to a result of the comparison being that the at least one of the transformed measured values exceeds the stored threshold value; and
generate a signal that signals that the event has occurred.

11. The device of claim 4, wherein the determination of the mother wavelet includes approximating the mother wavelet using a B-spline scaling function based on the Hölder exponent.

12. The device of claim 4, wherein the processor is configured to determine at which points in time within the time period the stored threshold value is exceeded by the transformed measured values, wherein the generation of the signal includes integrating information of the points in time into the signal.
